(19) United States
(12) Patent Application Publication
(10) Pub. No.: US 2007/0067054 A1
(43) Pub. Date: Mar. 22, 2007

(54) Programmable portable media player for guidance, training and games

(76) Inventor: M. Sherif Danish, Cupertino, CA (US)

Correspondence Address: JONES DAY, 555 SOUTH FLOWER STREET FIFTIETH FLOOR, LOS ANGELES, CA, 90071, US

(21) Appl. No.: 11/497,558

(22) Filed: Aug. 1, 2006

Related U.S. Application Data
(60) Provisional application No. 60/811,574, filed on Jun. 6, 2006.
(60) Provisional application No. 60/799,077, filed on May 10, 2006.
(60) Provisional application No. 60/718,442, filed on Sep. 19, 2005.

(51) Int. Cl. G06F 17/00; H04R 1/10

(52) U.S. Cl. 700/94; 381/74

(57) ABSTRACT

A portable media player system and method are provided. One of potential application of the portable media player system is to help guide a user through a religious activity. Another potential application is to assist a user in learning a language.

### CROSS-REFERENCE TO RELATED APPLICATIONS

The present application claims priority under 35 U.S.C. 119(e) to U.S. Provisional Application No. 60/811,574 filed Jun. 6, 2006, U.S. Provisional Application No. 60/799,077 filed May 10, 2006, and U.S. Provisional Application No. 60/718,442 filed Sep. 19, 2005, each of which is hereby incorporated by reference.

### BACKGROUND

1. Technical Field

The application generally relates to portable media player systems and methods.

2. Description of Related Art

Various types of portable media players are known such as portable CD players, portable DVD players, and portable MP3 players. Various types of media players used for instructional purposes are known such as language translators with voice and personal computer audio-visual software.

### SUMMARY

A portable media player system and method are provided. One potential application of the portable media player system is to guide a user through a predetermined activity. One exemplary activity is a religious activity. Another exemplary activity is the playing of a game. Another potential application is to assist a user in memorizing something. As an example, the portable media player could be used to assist a user in learning a non-native language. In another example, a user could be assisted in learning portions of a religious text.

### BRIEF DESCRIPTION OF THE DRAWINGS

FIG. 1A is a back view of an exemplary configuration of a head mounted audio playing device.

FIG. 1B is a side view of the audio playing device of FIG. 1A.

FIG. 2A is a front view of another exemplary configuration of a head mounted audio playing device.

FIG. 2B is a side view of the audio playing device of FIG. 2A.

FIG. 3A is a front view of yet another exemplary configuration of a head mounted audio playing device.

FIG. 3B is a side view of the audio playing device of FIG. 3A.

FIG. 4 is a more detailed view of an exemplary ear piece portion of an audio playing device, such as that illustrated in FIGS. 1A-3B.

FIG. 5 is a block diagram illustrating system components of an exemplary audio playing device such as that illustrated in FIGS. 1A-4.

FIG. 6 is a flow chart illustrating an exemplary sequence of steps that may be performed by an audio playing device, such as that illustrated in FIGS. 1A-5.

FIGS. 7A-D are flow charts illustrating exemplary steps of sub-sequences identified in FIG. 6.

FIGS. 8A-C are tables illustrating exemplary steps for 2 rakaa, 3 rakaa, and 4 rakaa prayers corresponding to the exemplary sub-sequence set forth in FIG. 7A.

FIG. 8D is a table illustrating exemplary steps for 2 rakaa Taraweeh prayer corresponding to the exemplary sub-sequence set forth in FIG. 7B.

FIGS. 9A-C are block diagrams illustrating exemplary data structures stored in the memory of an exemplary audio playing device.

FIGS. 10A-C are tables illustrating exemplary menus, prompts, and prayer files stored in the memory of an exemplary audio playing device.

FIG. 11 is a block diagram illustrating various functional components of an exemplary audio playing device.

### DETAILED DESCRIPTION

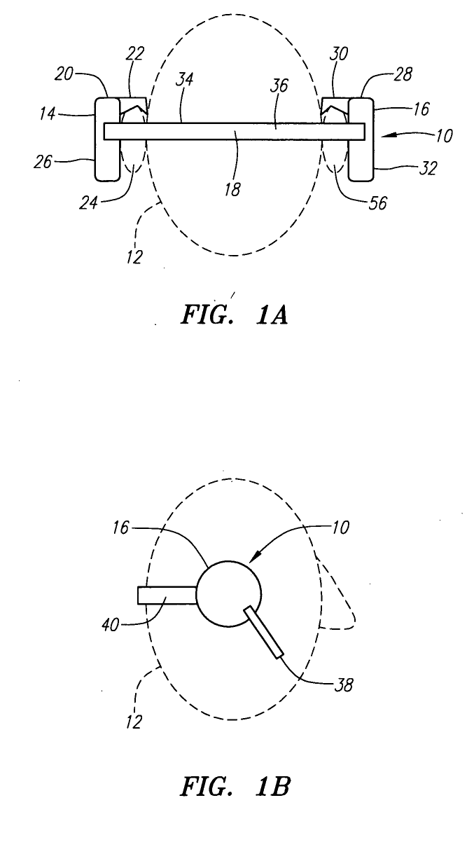

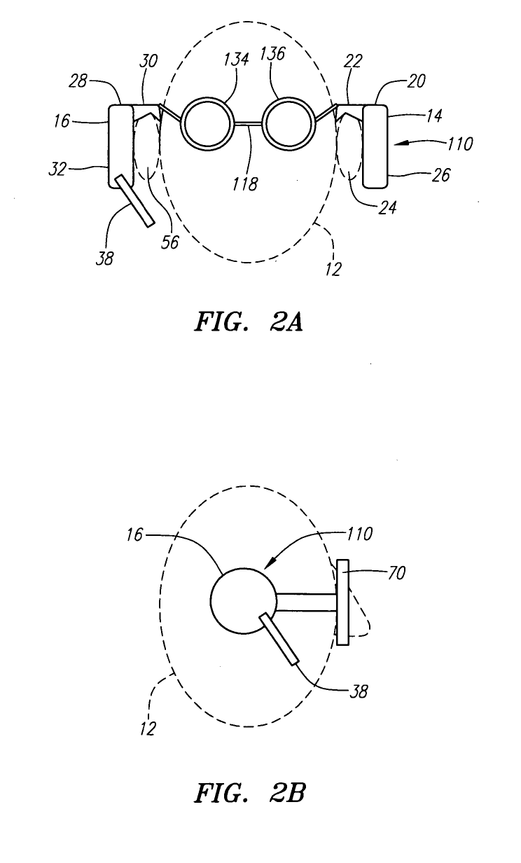

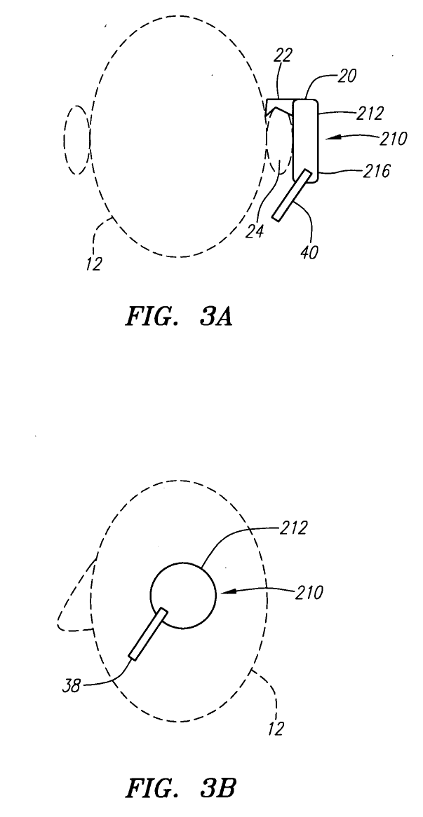

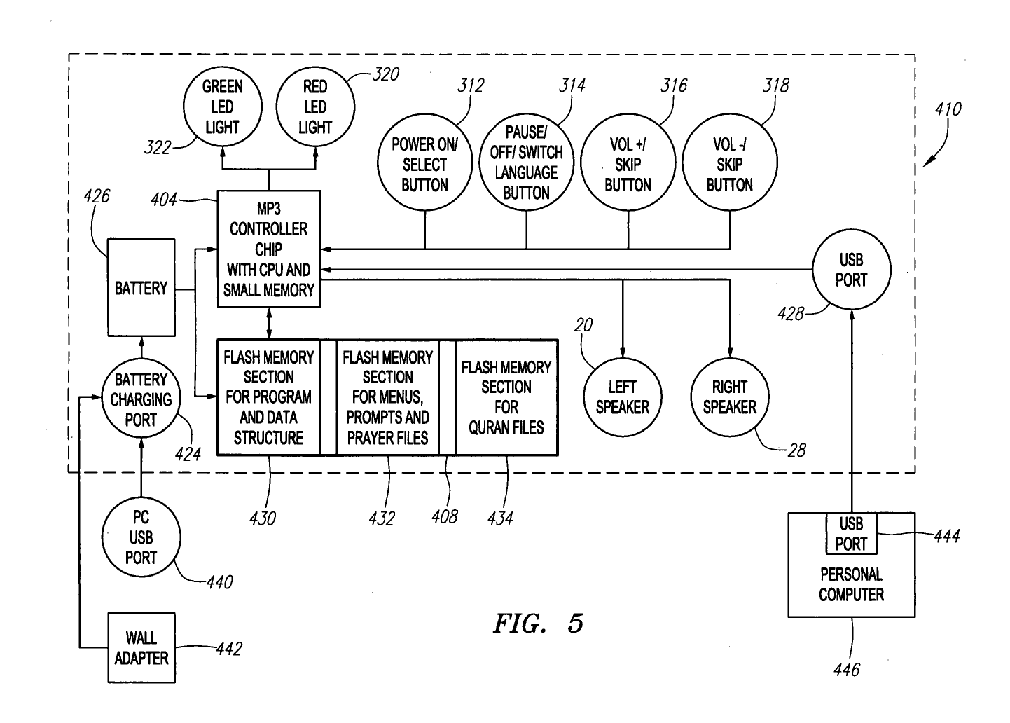

FIG. 1A is a back view of an exemplary audio playing device 10 mounted on a user's head 12. This exemplary audio playing device 10 has a left earpiece section 14, a right earpiece section 16, and a connecting section 18. The left earpiece section 14 includes a left speaker 20 and an ear mounting device 22 for use in positioning the left earpiece section 14 adjacent to the left ear 24 of a user. The left earpiece section 14 may optionally contain an enclosure 26 that houses electronic circuitry used in generating electrical signals that are provided to the left speaker 20 or a right speaker 28. The left speaker 20, in turn, converts received electrical signals to sounds for reception by the user's ear 24. In this example as well as the exemplary audio playing device configurations illustrated in FIGS. 2A-3B, the ear mounting device 22 is a hook or a holder that is kidney-shaped. However it should be understood that mounting device 22 could comprise other types of devices and/or shapes and structures that facilitate the desired positioning of the earpiece section 14 to the user's ear 24. For example, the earpiece could be formed to fit within or substantially within the ear or earlobe of the user similar to contemporary hearing aids and some or all of the electronics or electrical components illustrated in FIG. 5 can be integrated within the form fitting structure and controlled either by direct or wireless communication inputs.

The right earpiece section 16 is similar to the left earpiece section 14 and has similar components. The right earpiece section 16 also contains a right speaker 28, an ear mounting device 30 for positioning the earpiece on the right ear 56, and an optional enclosure 32 for housing electronic circuitry otherwise not housed in the left earpiece.

The exemplary audio playing device 10 also includes a connecting section 18. The connecting section 18 may comprise an elastic cable 34 implanted with electrical wires 36. The electrical wires 36 may connect circuitry in the left earpiece enclosure 26 and right earpiece enclosure 32 if both exist and may provide a signal path for signals from the left earpiece enclosure 26 and/or right earpiece enclosure 32 to the left and/or right speakers 20 and 28.

FIG. 1B is a side view of the exemplary audio playing device 10 of FIG. 1A. This view illustrates that a microphone 38 may also be connected to the audio playing device 10 for allowing voice signals from the user 12 to be sent to the audio playing device 10. This view also illustrates that a connecting section 40 alternatively may comprise a clamp which provides a mechanism for securely mounting the audio playing device 10 on the user's head 12 so that holders 22 and 30 are not necessary and may be eliminated from the audio playing device 10. In this example, the connecting section 40 is in the shape of a horseshoe if viewed from the top and in the shape of a question mark shape if viewed from side. Other shapes or configurations could also be used.

FIG. 2A is a front view of another exemplary audio playing device 110 mounted on a user's head 12. This exemplary audio playing device 110 also has a left earpiece section 14, a right earpiece section 16, and a connecting section 118. The left earpiece section 14 and right earpiece section 16 are similar to those sections in audio playing device 10 and contain similar components.

The audio playing device 110 includes a connecting section 118 that is configured in the shape of an eye-glass-type frame. This connecting section 118 comprises an elastic cable 134 implanted with electrical wires 136 for providing a signal path between the left earpiece enclosure 26, the right earpiece enclosure 32, the left speaker 20 and/or the right speakers 28.

FIG. 2B is a side view of the exemplary audio playing device 110 of FIG. 2A. This view illustrates that a microphone 38 may also be connected to the audio playing device 110 for allowing voice signals from the user 12 to be sent to the audio playing device 110.

FIG. 3A is a front view of an exemplary audio playing device 210 mounted on a user's head 12. This exemplary audio playing device 210 has a left earpiece section 212 which includes a left speaker 20 and an ear mounting device 22 for use in positioning the left earpiece section 212 adjacent to the ear 24 of a user. In this example, the ear mounting device 22 is a hook or a holder that is kidney-shaped but alternatively could comprise other types of devices and/or other shapes that facilitate the positioning of the earpiece section 212 adjacent the user's ear. Also the left earpiece section 212 contains an enclosure 216 that houses electronic circuitry used in generating electrical signals that are provided to the left speaker 20. The left speaker 20, in turn, converts received electrical signals to sounds and provides the sounds to the user's ear 24.

FIG. 3B is a side view of the exemplary audio playing device 210 of FIG. 3A. This view illustrates that a microphone 38 may also be connected to the audio playing device 210 for allowing voice signals from the user 12 to be sent to the audio playing device 210.

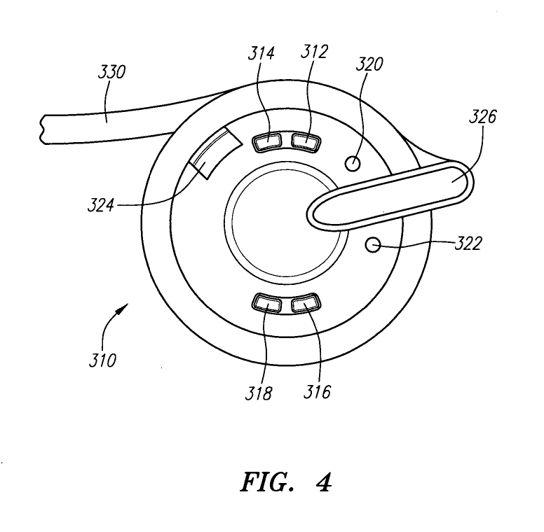

FIG. 4 is a more detailed view of representative earpiece 310 of an exemplary audio playing device, such as that disclosed and described in connection with FIGS. 1A-3B. This representative earpiece 310 has a power-on/select switch or button 312, a pause/off/switch language switch or button 314, a volume up/skip switch or button 316, a volume down/skip switch or button 318, a red LED light 320, a green LED light 322, and a battery charging port 324. While these elements are disclosed as being part of an exemplary earpiece 310, it should be understood that they may be located anywhere on the audio playing device.

The power-on/select button 312 is an input device for use by a user in turning the audio playing device on and also for use by the user when making selections at various times during operation of the audio playing device. The pause/off/switch language button 314 is an input device used by the user to either pause the playing of media by the audio playing device, to resume the playing of media after the audio playing device has been paused, to turn the audio playing device off, and to select a language option used by the audio playing device. The volume up/skip button 316 is used to increase the volume of the media being played and also to skip ahead for example forward to another media file. The volume down/skip button 316 is used to decrease the volume of played media and also to skip back for example to another media file. The green LED light 322 provides a visual indication that the audio playing device is turned on. The red LED light 320 provides a visual indication that the audio playing device, if being operated using batteries, needs to have the batteries replaced or recharged. A plug 326 of the connecting section 330 is used to electrically connect the connecting section 330 and the earpiece section 14.

In this example, only four buttons/keys are needed with two placed near the top of the device 310 and two located near the bottom of the earpiece 310. The placement and limited number of buttons in this exemplary earpiece 310 allows the user to operate the audio playing device without having to remove the device 310 to determine where the buttons are located. While in the present example multiple functions are employed in a single switch or button mechanism, it should be understood that each function may be placed on separate switch mechanism or may be combined in any manner to facilitate the desired functionality and operation of the audio playing device.

FIG. 5 is a block diagram illustrating exemplary circuit components 410 of an audio playing device, such as that illustrated and described in connection with FIGS. 1-4. This exemplary circuit components 410 are comprised of a controller circuit 404, memory 408, a power-on/select button 312, a pause/off/switch language button 314, a volume up/skip button 316, a volume down/skip button 318, a red LED light 320, a green LED light 322, a battery charging port 324, a battery 426, a USB port 428, a left speaker 20, and a right speaker 28. All of the components except for the left speaker 20 and battery 426 may be enclosed within and/or otherwise reside on the right earpiece of the audio playing device such as the exemplary earpiece 310 illustrated in FIG. 4.

The battery 426 and left speaker 20 may be enclosed within and/or reside on the left ear piece. In this manner the audio playing device may be weight balanced and configured to be used by a right handed user. It should be understood, however, that it is contemplated that the right and left earpieces be mechanically interchangeable or conformable so that a single audio playing device can be configured to either a right or left handed user. In addition, it should be understood that in a single-ear audio playing device, which does not include a left speaker 20, such as that illustrated in FIGS. 3A-3B that all of the exemplary circuit components illustrated in FIG. 5 (including the battery 426 but minus the left speaker 20) are enclosed within or otherwise reside on a single earpiece structure.

The controller circuit 404 in this example comprises a MP3 controller chip that contains a CPU and internal memory. The controller circuit 404, along with memory 408, are mounted on a printed circuit board preferably enclosed within the earpiece 310. The controller circuit 404 is operable to convert digital media files such as MP3 media files into analog signals that are communicated to one or more speakers 20, 28.

The memory 408 in this example is comprised of flash memory but other forms of memory could be used. The memory 408 provides a storage area for software programs which are transferred from the memory 408 to the controller circuit 404 to be executed. The memory 408 comprises three sections: a program and data structure section 430, a menu and voice prompt files section 432, and a media files section 434. In this example the media files section 434 comprises files of verses from the Quran.

The controller circuit 404 in this example is a programmable unit which is able to execute software or firmware programs stored in the memory 408 and to convert digital media files into analog signals to guide a user through the performance of at least one of a pre-defined activities. Alternatively, the function of executing software or firmware programs and the function of converting digital media files into analog signals can be performed by separated circuit elements. For example, the function of executing software or firmware programs can be performed by the controller circuit 404 while the function of converting digital media files into analog signals can be performed by a separated converter.

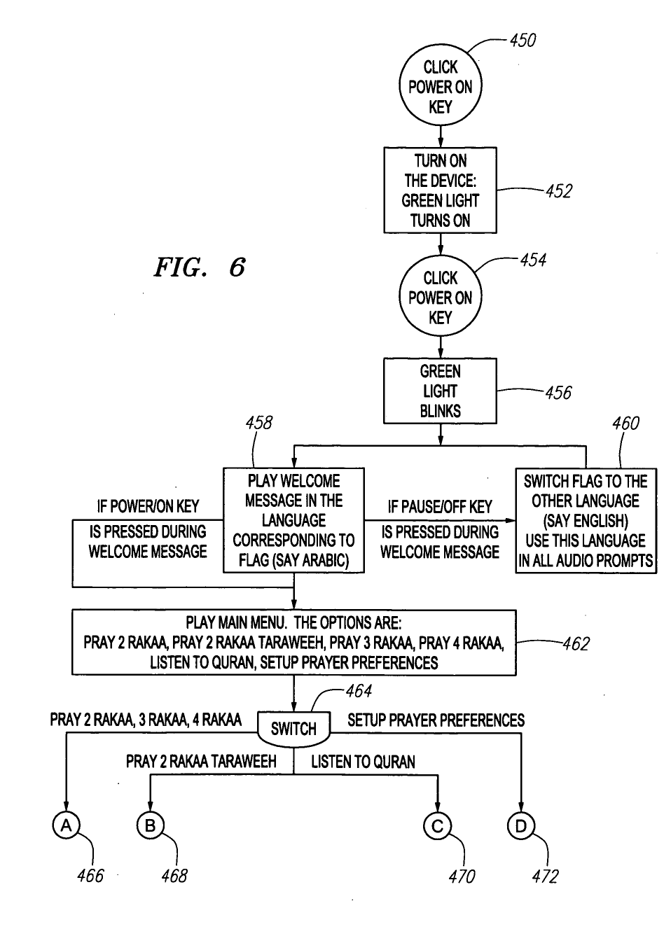

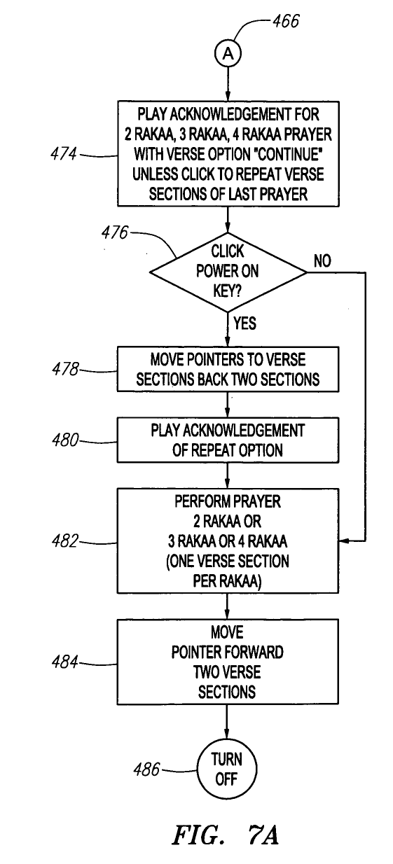

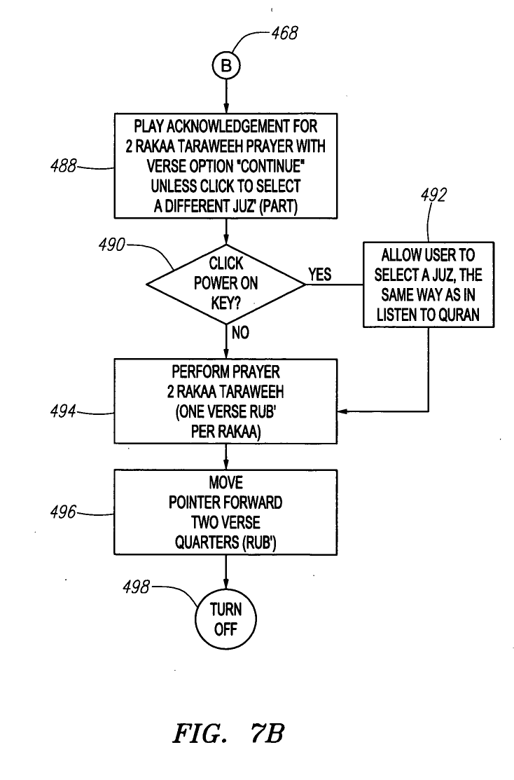

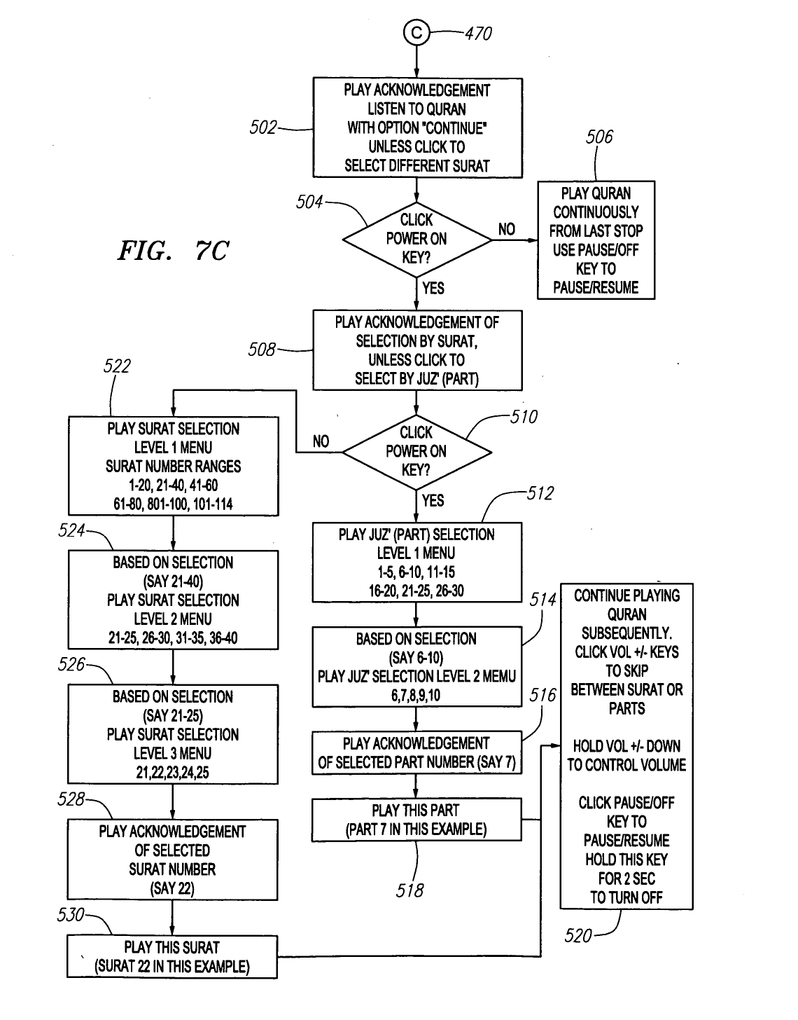

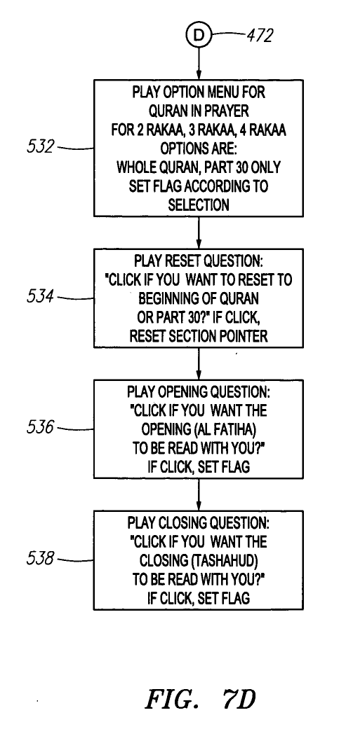

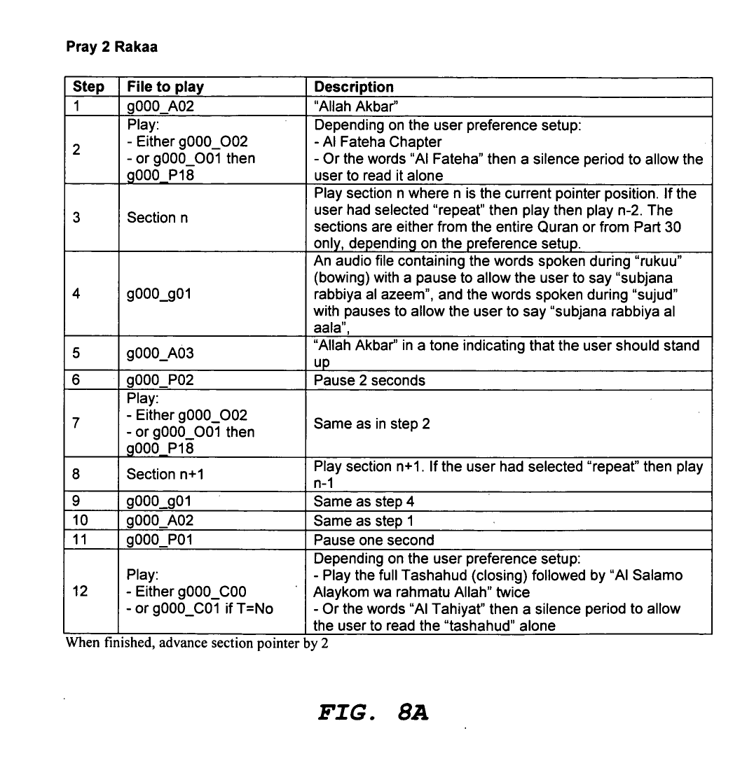

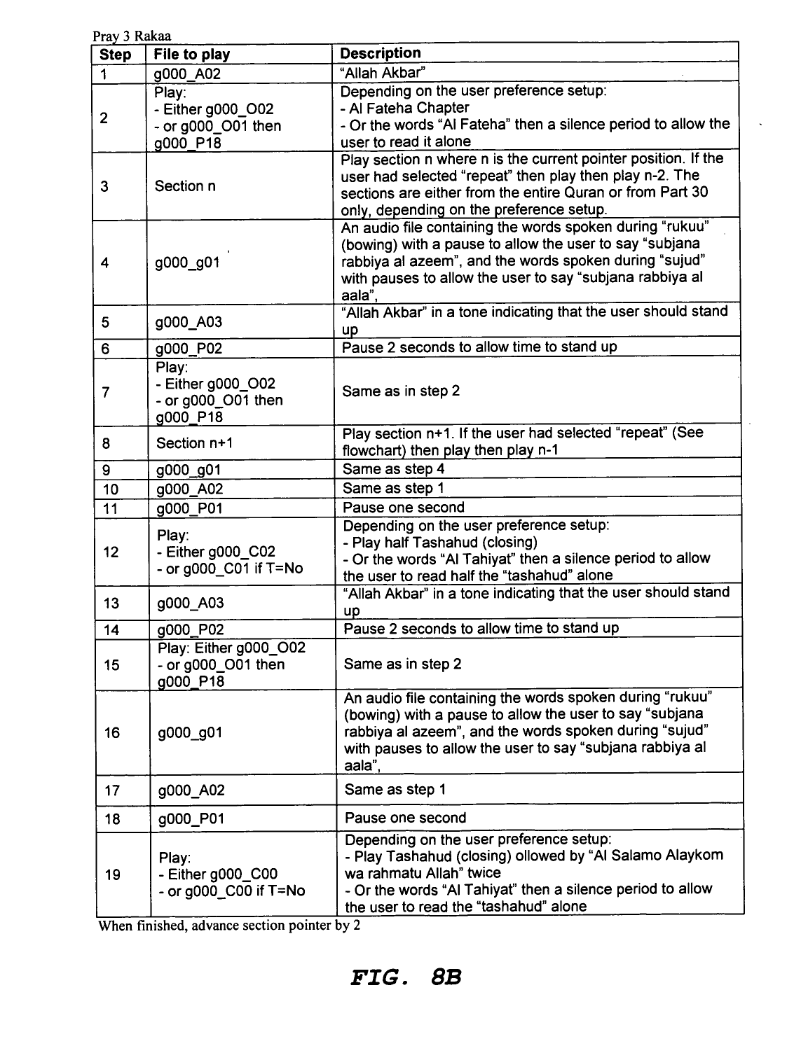

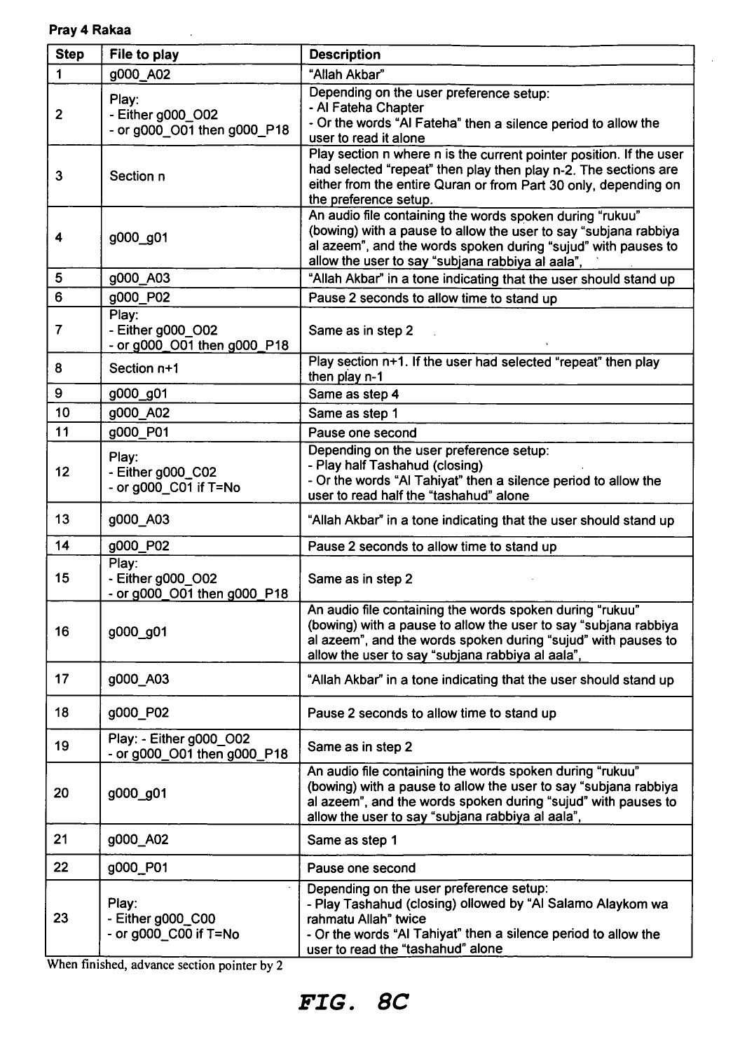

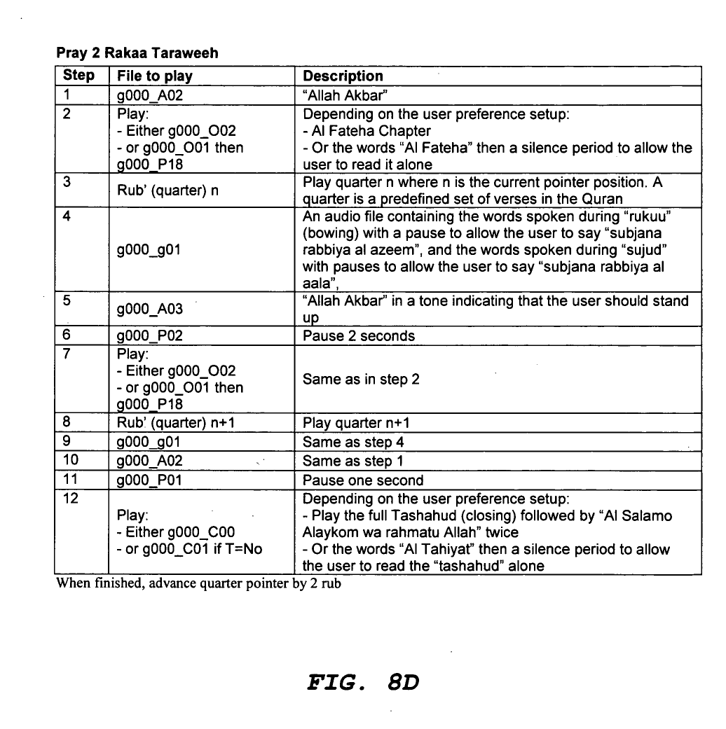

The program and data structure section 430 contains one or more binary program files that provide instructions for executing the logic described in the flow chart illustrated in FIG. 6. In addition, the program and data structure section 430 in this example contains one or more binary program files that provide instructions for executing the logic for guiding a user through an Islamic prayer process such as a two rakaa, three rakaa, four rakaa, or two rakaa Taraweeh as described and illustrated in FIGS. 7A-D and FIGS. 8A-D.

One of the five pillars of Islam is for Muslims to pray five times a day. In addition to these five required prayers, Muslims engage in other prayers. While Muslim prayers vary depending on the time, nature and purpose of the prayer, they share commonalities and differ in form primarily by number of prayer cycles or units, each unit of which are called a “rakaa.” The morning prayers (either the “Fajr” or “Shurooq”) are each comprised of two rakaas, the two mid-day prayers (the “Zhuhr” and “Asr” prayers) are comprised of four rakaas each, the sunset prayer (the “Maghrib” prayer) is comprised of three rakaas, and the evening prayer (the “Eshaa” prayer) is comprised of four rakaas. In addition, during the month of Ramadan, Muslims read or recite the entire Quran, which is made-up of thirty juz′ (parts) containing 114 surats (chapters) of varying lengths and in set order and which together are comprised of a total of 6236 ayat (verses). In addition, Muslims often pray what is referred to as “Taraweeh” prayers, which are comprised of multiple two rakaa prayers. At the end of those prayers, Muslims often ask God for personal assistance, guidance and wisdom in what are called “Duaa” and recite the sayings or actions of the Prophet Muhammad or his companions which are called “Hadith.”

The following is a brief description of the steps that are performed during Muslim prayers.
1. The praying Muslim standing, raises his or her hands up and says “Allahu Akbar” (God is Most Great).
2. Standing with hands folded over chest or at his or her side, the praying Muslim recites the first surat or chapter of the Quran in Arabic (surat al Fatiha). While in the same position, the praying Muslim then recites any other verses of the Quran that the praying Muslim chooses (the selected versus).
3. The praying Muslim then raises his or her hands up, saying “Allahu Akbar” and then bows and recites “subhana rabbiyal azim” (glory be to my Lord almighty) three times.
4. The praying Muslim then rises to standing position while reciting “samiaa allahu liman hamidah, Rabbana wa lakal hamd” (God hears those who call upon him; our Lord, praise be to you).
5. The praying Muslim then raises his or her hands up, saying “Allahu Akbar” and then prostrates on the ground reciting “subhana rabbiyal aala” (glory be to my Lord, the most high) three times while prostrated.
6. The praying Muslim then rises to a sitting position, saying “Allahu Akbar” and then prostrates again in the same manner (i.e., reciting “subhana rabbiyal aala” three times).
7. The praying Muslim then rise to a standing position saying “Allahu Akbar.”

The foregoing steps conclude one rakaa. The praying Muslim prays a second rakaa starting from Step 2. After two rakaas, the praying Muslim remains sitting after the prostrations and recites the first part of the Tashahhud in Arabic. If the prayer is only two rakaas long, the praying Muslim also recites the second part of the Tashahhud immediately after reciting the first part. If the prayer is longer than two rakaas (such as the mid-day, sunset, and evening prayers), the praying Muslim then stands up and begins again to complete the prayer, sitting again after all rakaas have been completed and then reciting the second part of the Tashahhud in Arabic. The praying Muslim then concludes his prayer by turning to the right and saying “assalamo alaykom wa rahmatollah” (peace be upon you and God's blessings) and then turning to the left and repeating the greeting “assalamo alaykom wa rahmatollah.” To the extent that the prayer being performed is a three or four rakaa prayer, the praying Muslim selected verses of the Quran in Step 2 are not recited after the second rakaa or in other words only Surat Fatiha is recited in Step 2 after the second rakaa of a prayer. Because, many Muslims have not memorized the entire Quran or even a majority of the Quran they often recite the same verses or largely the same group of verses over and over again during each prayer.

With regard to the power source components, a rechargeable battery 426 may be located in the left earpiece section 14. A battery charging port 424 is also provided in this example, where the battery charging port 424 has a USB connector for connecting the audio playing device 410 to a power source. The power source may be alternatively provided via a USB cable connected to a USB port 440 of a PC or via a wall adapter cable 442 that connects a wall power outlet to the battery charging port 424.

Additionally, a separate USB port 428 may be provided for communication with a PC. The USB port 428 may be used for initially loading software and audio files onto the device. It may also be later used by the user to load newer versions of software and audio files. For example, it is contemplated that the user may have a selection of audio recitations of the Quran recited by different individuals and may use the USB port 428 to load the desired recitations on to the audio playing device.

FIG. 6 and FIGS. 7A-D are flow charts illustrating exemplary steps performed by an audio playing device, such as that illustrated and described in connection with FIGS. 1-5, in guiding a user through the performance of an activity. In the examples that follow, the user is guided through one or more user selected Islamic religious activities. The device, however, may be used to guide a user through other activities. For example, the device may be used to guide a user to learn a foreign language which requires repeated mimic processes. The device also may be used to guide a user to memorize a new poem, a classical article, or an important religious document.

Also in the following examples, the device operates using voice prompts in a way similar to conventional interactive voice response (IVR) system such as those frequently used by organizations when contacted by phone (e.g., for option 1 press 1, for option 2 press 2, etc . . . ). In the example illustrated herein, typically only one key (i.e. the power-on button 312) is used to respond to voice prompts. One exception is the use of the pause/off button 314 to switch languages between Arabic and English during the audio welcome message. The voice prompts are of two kinds: a menu, where the user selects a desired option, or a prompt that informs the user of a particular setting and asks the user to respond only if a change is desired.

As shown in the first step 450 in the flow chart of FIG. 6, a user engages the power-on button 312 to turn on the audio playing device (e.g., 10, 110, 210), the green LED 322 turns on (step 452) to provide a visual indication that the device is powered and the system is ready to start. If the user engages the power-on button 312 again (step 454), the green LED 322 blinks (step 456) and the audio playing device (e.g., 10, 110, 210) starts to play a welcome message (step 458). This welcome message briefly describes operational features of the device such as the pre-defined activities of the device. The welcome message can be interrupted (by the user pressing the pause/off key or button 314) at any time to allow the user to switch the language that the welcome message is played (e.g. between Arabic and English) (step 460). It is contemplated that the device may have the capabilities to employ many languages in addition to Arabic such as English, Spanish, German, Russian, Mandarin, Persian, Urdu, etc. or any other language or dialect thereof and that the user may select any one of those languages. By continuously engaging the power-on key 312, the welcome message can be skipped to allow the sequence to jump ahead to the main menu (step 462).

In step 462, the main menu is played and the user is presented with six options: (1) pray two rakaa (a rakaa as previously described is a unit of prayer) usually during morning or sunna prayer, (2) pray three rakaa usually during sunset prayer, (3) pray four rakaa usually during noon, afternoon, and evening prayer, (4) pray two rakaa Taraweeh which is a long evening prayer during the month of Ramadan, (5) listen to the Holy Quran outside of prayer time, and (6) set up preferences of prayer process. A user selection of one of the six options in step 464 will cause the sequence as illustrated in FIG. 6 to proceed to one of four sub-sequences A-D (466, 468, 470, and 472).

FIGS. 7A-D are flow charts illustrating exemplary steps for each of the four sub-sequences A-D (466, 468, 470, and 472) identified in FIG. 6. FIG. 7A is the sub-sequence of exemplary steps when options 1, 2 or 3 (i.e., pray 2 Rakaa, 3 Rakaa, or 4 Rakaa) is selected by the user. FIG. 7B is the sub-sequence of exemplary steps when option 4 (i.e., pray 2 Rakaa Taraweeh) is selected by the user. FIG. 7C is the sub-sequence of exemplary steps when option 5 (i.e., listen to Quran)is selected by the user. And, FIG. 7D is the sub-sequence of exemplary steps when option 6 (i.e., setup prayer/user preferences) is selected by the user.

In FIG. 7A, the sub-sequence begins by first playing a message that acknowledges that the selection of a two rakaa, three rakaa or four rakaa prayer and provides the user with the option of continuing the prayer sequence from the point at which the last sequence ended or to repeat the last prayer sequence ( step 474). At step 476, if the repeat operation or option was selected by the user engaging the power-on key 312 (reflecting the user desire to repeat verse sections from the previous prayer) the sub-sequence proceeds to step 478. At step 478, a pointer is moved two sections back to the verse section that was employed in the last prayer. Then, in step 480, an acknowledgement of the repeat option is played. Then the sequence moves on to step 482 where a two rakaa, three rakaa or four rakaa prayer is performed. Alternatively, if the continue operation was selected (i.e., repeat option not selected) then the sequence would jump ahead to step 482 skipping over steps 478 and 480.

In step 482, if two rakaa was previously selected, then the audio playing device would guide the user through the 2 rakaa prayer. First, the user selects a menu item “Pray 2 Rakaa.” The audio playing device 10 plays the phrase “Allah Akbar” and pausing to allow the user to repeat “Allah Akbar” to start the prayer. The audio playing device recites the Surat el “Fatiha” (the first Surat in the Quran, which is repeated during each rakaa or prayer cycle) or pauses/is silent (e.g., for approximately eighteen seconds) to allow the user to recite the Fatiha him or herself (depending on setting, see discussion in connection to FIG. 7D). If “repeat last verses” was selected (see steps 474, 476, 478, 480 of FIG. 7A), then the audio playing device plays verses for the Quran that were played in the last prayer, otherwise, the audio playing device plays the next verses of the Quran from where it left off at the last prayer. The audio playing device then plays “Allah Akbar,” and then pauses/is silent (e.g., for approximately five seconds) to allow sufficient time for the user to bow and say “Subhana rabbiyal Azim” three times. Alternatively, the audio playing devices recites “Subhana rabbiyal Azim” three times if this setting is desired and selected. Then the audio playing device plays “Samiaa allaho leman hamida,” then pauses/is silent for one second to allow sufficient time for the user to recite the phrase and to rise to a standing position. The audio playing device then plays “Allah Akbar” and pauses/is silent for five seconds to allow user to perform sujud (prostration and say “subhana rabbiyal aala” three times). Alternatively, the audio playing devices recites “subhana rabbiyal aala” three times if this setting is desired and selected. The audio playing device then plays “Allah Akbar” and pauses/is silent (e.g., for approximately one second) to allow the user to rise to a sitting position. Then audio playing device plays “Allah Akbar” and pauses/is silent ( e.g. for approximately three to five seconds) to allow user to bow and say “subhana rabbiyal aala” three times. Alternatively, the audio playing devices recites “subhana rabbiyal aala” three times if this setting is desired and selected. The audio playing device then plays “Allah Akbar.”

All of the steps described in the previous paragraph constitute one rakaa. Therefore, if two rakaa is selected, the steps described in the previous paragraph are repeated once as previously described. FIG. 8A is a table describing representatives files that would be played by the audio playing device in step 482 for a two rakaa prayer. If three rakaa is desired, the steps described in the previous paragraph are repeated twice as previously described. FIG. 8B is a table describing representatives files that would be played by the audio playing device in step 482 for a three rakaa prayer. Similarly, if four rakaa is selected, the steps described in the previous paragraph are repeated three times. FIG. 8C is a table describing representatives files that would be played by the audio playing device in step 482 for a four rakaa prayer.

At the end of each prayer (whether two rakaa, three rakaa or four rakaa), the audio playing device plays “Allah Akbar” and then plays the appropriate part or parts of the “Tashahhud” or, depending of the user setting, pauses/is silent (e.g., for approximately twenty to forty seconds) to allow sufficient time for the user to recite the first and/or second parts of the Tashahhud as the case may be). The audio playing device then plays “assalamo alaykom wa rahmatollah” twice. If “Duaa” option is selected, then-the audio playing device recites Duaa and/or Hadith and pauses/is silent at appropriate intervals to allow the user to repeat them. At this point, step 482 is completed. The pointer is then moved forward two verse sections of the Quran as shown in step 484. Then the device turns off (step 486) to finish the prayer sequence.

If a full Taraweeh prayer is selected by the user, the sub-sequence illustrated in FIG. 7B will be performed. A full Taraweeh prayer is a sequence of four, two rakaa Taraweeh prayer sequences separated by short rest periods. It is typically prayed in the evening during the month of Ramadan. At each two rakaa Taraweeh, the user will listen to two quarters of the Quran which will make the prayer last about fifteen minutes. The device manages the pointers to Quran quarters separately from the pointers to the Quran sections discussed above recited in daily prayers. The total time to perform the Taraweeh prayer is therefore four times fifteen minutes which is one hour. The Taraweeh prayer process is also used for the “Night Standing” prayers outside of the month of Ramadan. Hence, there are many sections of verse in each quarter of the Quran.

In step 488, the audio playing device plays a message that acknowledges that a two rakaa, Taraweeh prayer with verse option was selected and provides the user with the option of continuing the prayer sequence from the point at which the last sequence ended or repeating the last prayer sequence. While in step 490, if the power-on key 312 is engaged, the user is allowed to select a specific juz (part) of the Quran (step 492) and the sequence proceeds to step 494. If the power-on key 312 was not engaged, the sequence proceeds to step 494. At step 494, the two rakaa, Taraweeh prayer is performed. After step 494 is finished, the pointer is moved two quarters forward (step 496). The user can then select another 2 rakaa Taraweeh prayer and repeat the cycle as many times as he wishes to complete the Taraweeh prayer. FIG. 8C is a table describing representatives files that would be played by the audio playing device in step 494 for a two rakaa, Taraweeh prayer.

Referring to FIG. 7C, the user can select this option from the main menu to listen to the Quran outside of performing a prayer. The device informs the user that the Quran will be played from where the user last left off unless the user selects a different surat (chapter) from which to begin by engaging the power-on key 312. If the user so chooses, the device will instruct the user that the selection will be by surat (chapter) number unless the user chooses to select by part number. In this example, the Quran is divided into 30 parts in addition to the 114 chapters or surats as will discussed in more detail below.

The first step of the sub-sequence illustrated in FIG. 7C is for the device to play an acknowledgement message informing the user that the “listen to Quran” option was selected (step 502). While in step 504, the user can select the option of choosing where to begin the playing of the Quran by engaging the power-on key 312 upon hearing the acknowledgement message. A second acknowledgement message may then be played allowing the user to select between the option of selecting recitation of Quran based on a selection of a particular “surat” or chapter or based on the selection of a particular “part” (step 508). If the power-on key 312 is engaged a second time, a play by juz′ (part) selection has been made (step 510). Otherwise, play by surat (chapter) (step 522) is selected. While in step 504, if the power-on key 312 is not engaged, the Quran will be played beginning from where it ended playing in the last prayer sequence (step 506).

If the user selects the option to of playing a particular surat of the Quran, the sequence will proceed to step 522 wherein the audio playing device will ask the user to select one of six ranges of Surat numbers. The sequence will then proceed to continue to narrow the selection until the user is provided the option of selecting the particular surat that he or she desires to listen to (Steps 524, 526). In the example, illustrated in FIG. 7C, the user selects Surat number 22 (known as “Al Hajj”), by first selecting the group of surats numbered 21-40 and then selecting the group of surats numbered 21-25 and then selecting surat 22. Once a specific surat (chapter) is selected, the device plays an acknowledgement (step 528) and then plays that selected surat (chapter) as shown in step 530.

If the user selects the option to of playing a particular juz′ (part) of the Quran, the sequence will proceed to step 512 wherein the audio playing device will ask the user to select one of six ranges of parts numbers. The sequence will then proceed to continue to narrow the selection until the user is provided the option of selecting the particular part that he or she desires to listen to (Steps 514). In the example, illustrated in FIG. 7C, the user selects parts number 7, by first selecting the group of parts numbered 6-10 and then selecting part 7. Once a specific part is selected, the device plays an acknowledgement message advising the user of his or her selection(step 516) and then plays that selected part or juz′ as shown in step 518.

Either a specific surat (chapter) is selected (step 530) or a specific juz′ (part) is selected (step 518), the next step is always step 520 where the selected surat (chapter) or juz′ (part) is played. The volume up/skip button 316 can be used to skip between surat (chapter) or juz′ (part) by engaging the button such as a click. The volume up/skip button 316 can also be used to control the volume by a second type of engagement to the button such as holding the button for a period of time. The pause/off/switch language button 314, can be used to pause or resume the device by engaging the button such as a click. The pause/off/switch language button 314, can also be used to turn off the device by a second type of engagement to the button such as holding the button for a period of time.

Referring to FIG. 7D, this option in the main menu allows the user to select various settings by proceeding through a option selection steps 532-538. One setting defines the scope or portions of the Quran to be recited during prayer. The two options for this setting (step 532) are (1) full or whole Quran or (2) only part 30 of the Quran, which is comprised of shorter surats and therefore often preferred by beginners and children. The second setting (step 534) determines whether to reset the section pointers to the beginning of the Quran or the beginning of part 30 based on the first setting. Hence step 534 allows the user to reset the pointers on the audio playing device. The third setting (step 536) allows the user to select whether the audio playing device will play the surat Fatiha during each rakaa or be silent for a period of time sufficient for the user to recite the Fatiha. Similarly, the fourth setting (step 538) allows the user to select whether the audio playing device will play the Tashahud (closing ) or be silent for a period of time sufficient for the user to recite the Tashahud.

Many Muslims have memorized the Fatiha and the Tashahud and do not require either of them to be recited by the audio playing device and hence these options or user preferences may be beneficial to many users. Based on the foregoing user selections or preferences, flags or pointers will be set and used to control the device while it is guiding the user through an activity such as prayer. It should be understood, however, that any number of user preferences may be employed to control any aspect of the audio playing device. Hence it is contemplated that there may be a user selection preference for such features as: (1) controlling or setting the duration of particular pause or silence times during the prayer, (2) control over each aspect of a particular prayer that is to be played by the audio playing device, for example user selections to allow for silence rather than playing “subhana rabbiyal azim” or subhana rabbiyal aala” and (3) the ability to select a particular or customized play list of surats or Quran parts or verses for playing during prayer and to listen to outside of performing prayers.

In addition, it is contemplated the device may have a user preference selection that results in the device reciting on a portion of a section or surat during prayer (perhaps the beginning and maybe end of the Quran section and is silent during the interim to allow the user to recite the un-played portions in silence without reliance on the device). It is also contemplated that the device might include user selections that control volume control for the various audio played by the audio playing device. For example it is contemplated that the user may select a higher volume when the device is playing back prayer process files and/or menu files and a lower volume when the device is playing back Quran content files.

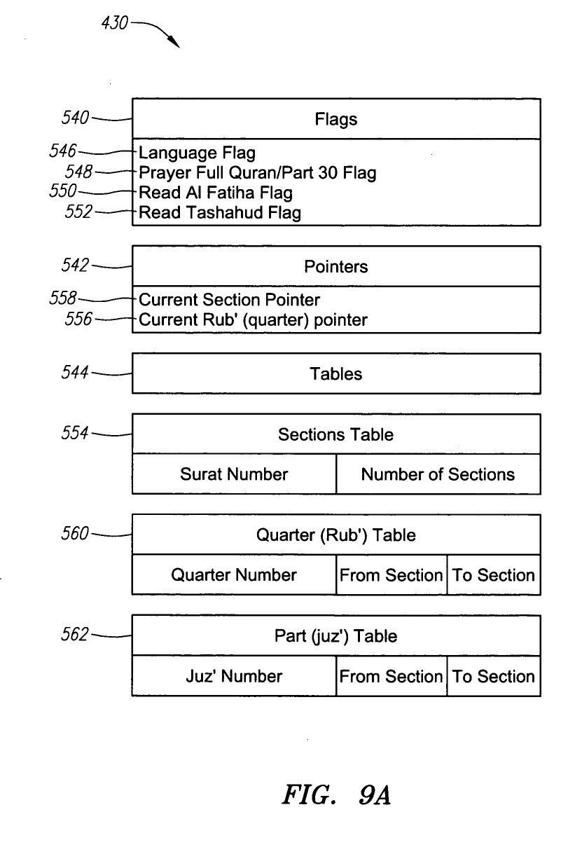

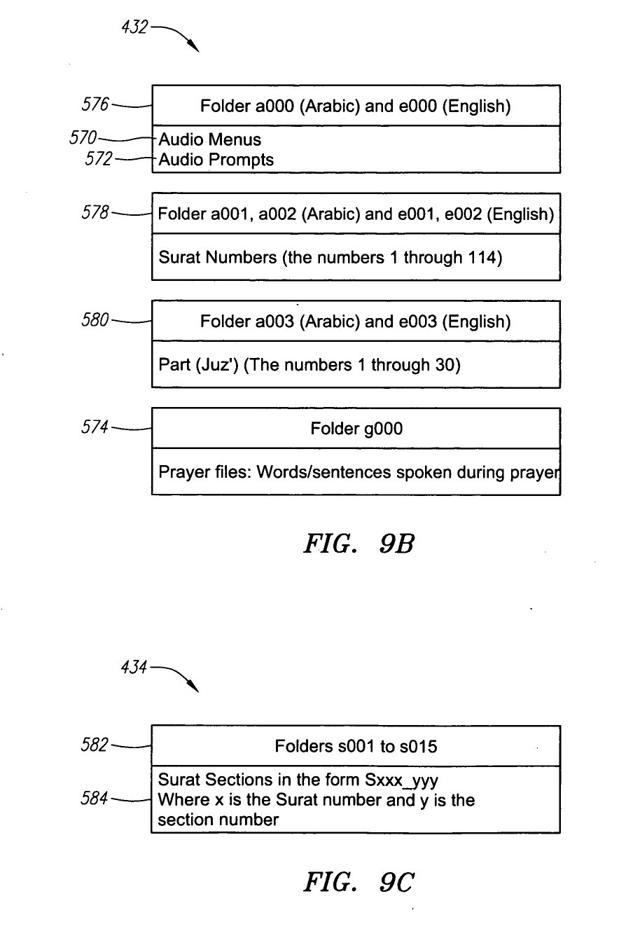

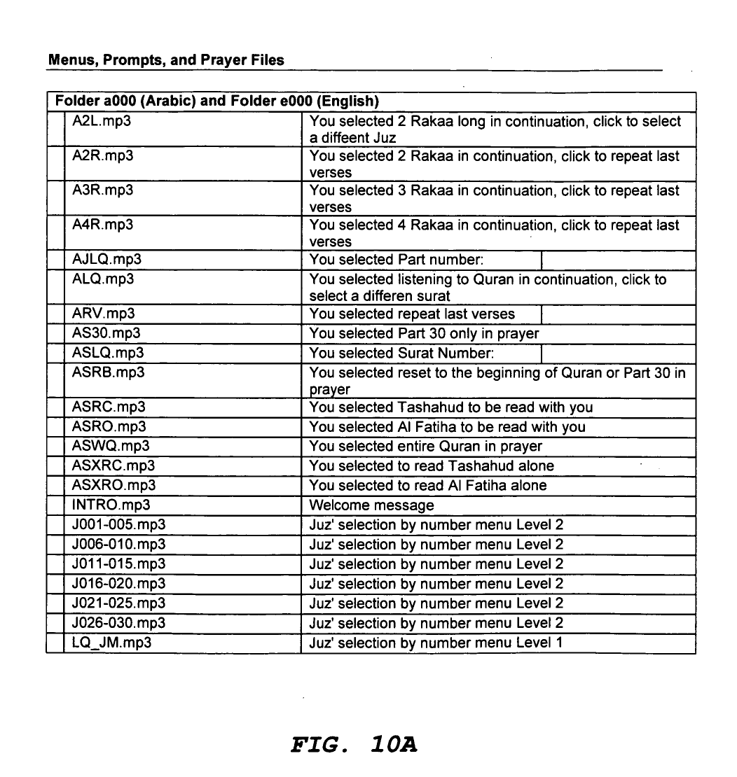

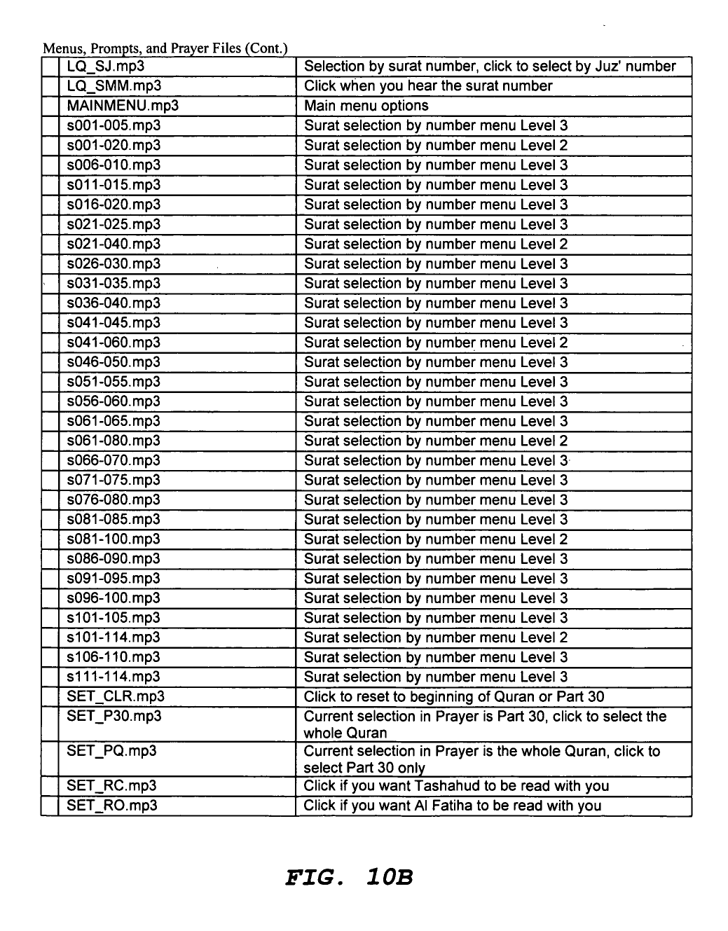

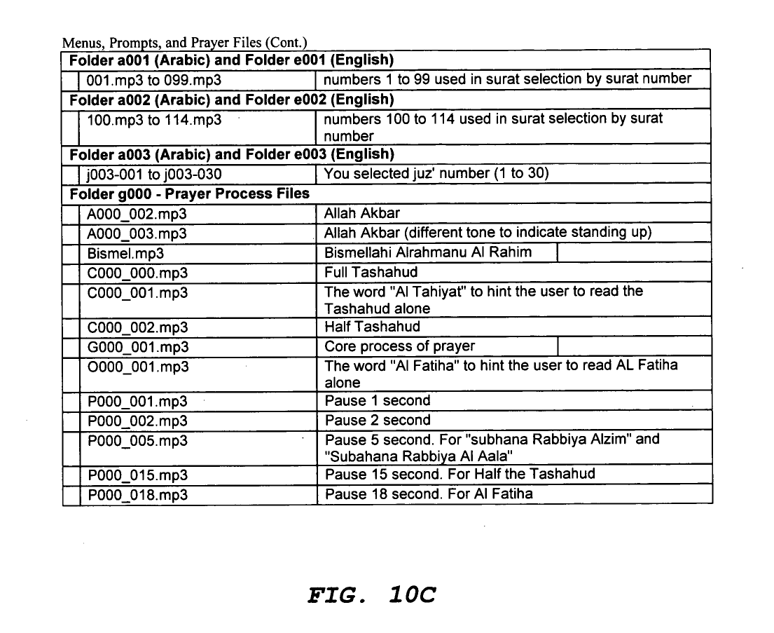

FIGS. 9A-C are block diagrams illustrating exemplary data structures stored in the memory of an audio playing device such as that illustrated and described in connection with FIGS. 1-8D. FIGS. 10A-C are tables illustrating exemplary menus, prompts, and prayer files stored in the memory of an audio playing device. FIG. 9A is data structure section 430 which includes flags 540, pointers 542 and tables 544 including section tables 554, quarter (Rub′) tables 560 and part (Juz′) tables 562. The following flags are persistent in that their setting stays in memory even when the device is turned off. The language flag 546 is set to either Arabic or English (or any other language) and can be switched between the languages by engaging the pause/stop button 314 during the welcome message. The Quran or Part 30 flag 548 is set in the preference phase of operation and instructs the device as to which portion of the Quran files may be played during prayer (whole Quran or Part 30 only). The read Al Fatiha flag 550 is set in the preference setup option phase and instructs device whether to play the file having the recitation of surat Al Fatiha during prayer or to be silent for a set period of time sufficient to allow the user recite it while the audio playing device is silent. The read Al Tashahud flag 552 is set in the preference phase and instructs the device whether to play the file having the recitation of Al Tashahud during prayer or to be silent for set period of time sufficient to allow the user recite while the audio playing device is silent.

The current section pointer 558 points to the section (a section is a set of Quran verses in one media file) to be read in the next prayer. Two sections are read in each prayer during the first and second rakaa (one section per rakaa). The current Rub′ pointer 556 points to the first section of the next rub′ (quarter) to be read in the next two Rakaa Taraweeh prayer. A quarter is a pre-determined set of sections (or media files). Two quarters are read in each Taraweeh prayer, one in each rakaa.

The Quran contains 114 surats (chapters) numbered 1 to 114. Each surat (chapter) contains several verses. Some surats (chapters) have hundreds of verses and some have only a few. The Quran is also divided into 30 parts of approximately equal length (e.g., having approximately the same number of words). Parts are numbered from 1 to 30. Each part consists of a set of verses that can start and end in the middle or end of a surat (chapter). A part is divided evenly into eight (8) rub′ (quarters). During a regular prayer, the worshiper reads just a few verses from the Quran (much less than a quarter). The representative implementation divide the Quran into “sections” that correspond to what people typically read in a prayer (one section per rakaa, in the first two rakaa's). In Taraweeh prayer, the worshiper reads one quarter in each rakaa (i.e. two quarters in each prayer of 2 rakaa Taraweeh).

The section table 554 contains the list of 114 surats (chapters) and the number of sections in each. If the device wants to play Surat 75 for example, it will look for a file named s075_{—}001 (Surat 75, Section 1) and play the number of sections mentioned in the table. If the table will show 4 sections for Surat 75. The application will therefore play s075_{—}001 to s075_{—}004. Alternatively, if the current section pointer is at Surat 75 section 1, then during for example an evening (Eshaa) 4 rakaa prayer selected use of the audio playing device, the audio playing device will play Surat 75 section 1 and section 2, unless the repeat option (see step 474-480, FIG. 7A) is selected, in which case the audio playing device would play the last two sections of Surat 74.

The quarter table 560 contains the list of 240 quarters (thirty parts times eight quarters per part), and the first and last section of that quarter. For a example, the third quarter in the Quran consists of Surat 2 (“Al Bakara”) sections 14 to 17 (which correlate to files s002_{—}014 to s002_{—}17).

The part table 562 contains pointers to the beginning and end of each part. For example, Part 3 is from file s002_{—}96 (Surat 2, Section 96) to file s003_{—}23 (Surat 3, Section 23).

Referring FIG. 9B, the menu and voice prompt files section 432 contains media files (MP3 files in this example) in special folders. The first set of folders 576 contains: welcome message, audio menus 570 and prompts 572 in both Arabic and English (which are identified as “a” and “e” files respectfully). An audio menu 570 is media file, in this example an MP3 or similar digitized audio files that asks the user to engage a button or to state a command when the user hears the desired option. The menus provide enough time for a user to click button or to state a command when (or shortly after) the desired option is heard. The software in the audio device detects the time of the click (or in the case of voice commands, includes voice recognition to process the user commands) and determines which option was chosen. The main menu (element 462, FIG. 6) is one representative example of how and an audio menu 570 could be employed.

An audio prompt 572 is a media file (MP3 file in this example) that instructs the user regarding the current setting of an option and asks the user to respond if the user wants to select another option. The software detects a response or lack thereof at the appropriate time and functions in an appropriate manner. For example, steps 534, 536 and 538 in FIG. 7D are steps performed by audio prompts. The menu and voice prompt files section 432 also contains the necessary files to perform a two rakaa, three rakaa, four rakaa, or two rakaa Taraweeh prayer.

A second set of folders 578 contain all 114 surat (chapter) numbers of Quran. A third set of folders 580 contain all 30 juz′ (part) numbers of Quran. A fourth folder 574 contains prayer process files to be displayed by the audio playing device.

FIGS. 10A and 10B show a list of files in the first set of folders 576. The left column are file names and the right column are description for each of the files. FIG. 10C is a list of files in the second set of folders 578, the third set of folders 580, and the fourth folder 574.

There are three kinds of media files (MP3 files in this example) in terms of their content: (1) Audio menus 570 and prompt files 572 (in Arabic and English); (2) Prayer process files (Arabic files read during prayer); and (3) Content (Quran files in this example).

Referring to FIG. 9C, the Quran files section 434 contains the entire Quran in multiple MP3 files in multiple folders such as folder 582. Each folder contains the MP3 files of one or more surats (chapters) 584. Alternatively, the folders could be arranged so that each surat (chapter) occupies one folder. The MP3 files are named Sxxx-yyy where xxx is the surat (chapter) number and yyy is the section number. A section is a set of Quran verses that stop at logical points to convey a message during prayer, and are often about one minute in length. Sections are grouped in the data structure to form quarters. A rub′ (quarter) is a set of Quran verses that cover a full rub′ (quarter or 1/240 of the Quran) are used in Taraweeh prayer. A completed list of Quran files is shown in Appendix 2 of the U.S. Provisional Application No. 60/811,574 filed Jun. 6, 2006.

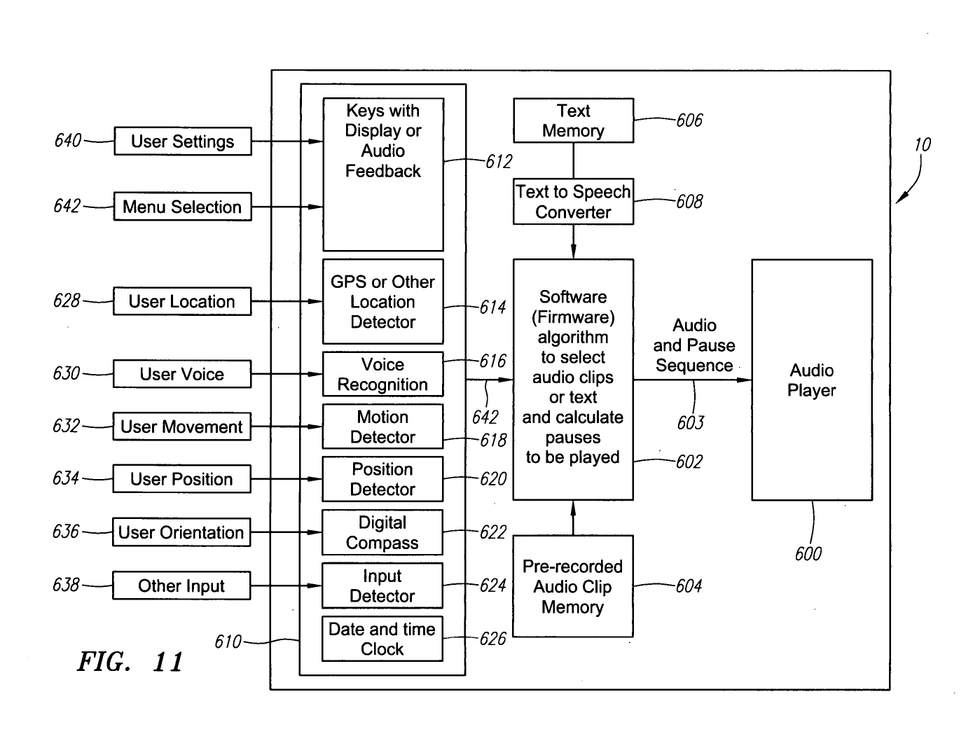

FIG. 11 is a block diagram illustrating various components of an exemplary audio playing device, such as that illustrated and described in connection with FIGS. 1-10C. The device comprises an audio player 600 and a memory area that is partitioned into program memory 602, audio clip memory 604, and text memory 606. In addition, the audio player has a text to speech converter 608 and a user interface block 610.

The audio player 600 is able to convert an audio and pause sequence 603 retrieved in digital format from audio clip memory 604 into analog signals. The other source of an audio and pause sequence 603 comes from the text to speech converter 608 which converts text stored in the text memory 606 into an audio format. The audio player 600 is able to convert the digital audio and pause sequence 603 into an analog format for playing through a speaker. The converting function of the audio player 600 can be performed by the MP3 controller chip 404 (shown in FIG. 5) or a separate converter contained in the audio player 600. The exemplary audio player 600 comprises a MP3 controller chip 404 that is connected to at least one speaker. The exemplary MP3 controller chip 404 may comprise a microprocessor, a CPU, a digital signal processor (DSP), a programmable logic device (PLD) or other logic devices. The exemplary MP3 controller chip 404 also incorporates a small memory.

The method of sending out the audio and pause sequence 603 from the pre-recorded audio clip memory 604 and the text memory 606 depends on a software or firmware algorithm implemented in instructions or code stored in the program memory 602. The pre-recorded audio clip memory 604, the text memory 606 and the program memory 602 used to store the code for the software or firmware algorithm are all preferably flash memories. Since the data stored in the text memory 606 is not in audio format, therefore, a text to speech converter 608 is required to convert the text data stored in the text memory 606 into an audio and pause sequence 603.

The device if further comprised of user interface block 610 which is able to receive external input or environmental data for use in interrupting or changing the programming sequence 603 controlled by the program memory 602. The exemplary user interface block 610 contains a user input block 612, a GPS or location detector 614, a voice recognition component 616, a motion detector 618, a position detector 620, a digital compass 622, and an input detector 624.

The user input block 612 includes some buttons/keys (e.g., alpha-numeric keys or subset thereof) with display or audio feedback. The GPS or location detector 614 is used to determine the global location 628 of the user. The voice recognition component 616 is used to receive and analyze words spoken by a user 630. The motion detector 618 may be used to detect a user's movement 632. The position detector 620 may be used to detect a user's position 634, such as whether the user is standing, kneeling or prostrating. The digital compass 622 may be used to detect the user's orientation 636. The input detector 624 may be used to detect other inputs 638.

The interaction between the audio playing device and the user can also be through a computer and a display such as a LCD screen display 612, instead of, or in addition to, audio prompts. The user could make selections by selecting options displayed on the screen display 612, such as menu screen that feeds into a sub-menu screen until the user finds the desired selection option.

The exemplary audio playing device (e.g., 10, 110,210) may also be used outside of prayer to listen to specific surat (chapter), Duaa′ (wishes addressed to God) or Hadith (teachings of the prophet Mohammed), which could also be stored in discrete files in memory and indexed similar to the Quran content files. The exemplary device may also be used to play or replay specific texts to allow a user to memorize the text.

With a GPS or a location detector 614, the exemplary audio playing device 10 is able to determine the direction to which the user must face in order for the user to face predetermined destination location, such as the city of Mecca to which Muslim people typically face when they pray. After a direction from the user to Mecca is determined, the audio playing device 10 which has an integrated digital compass 622 can guide the user to the orientation of the Mecca kaaba through an audio instruction. The audio playing device 10 may optionally provide a background sound of the Mecca kaaba ambiance and voices to add spirituality to a prayer.

The exemplary audio playing device 10 may include a date and time clock 626 in the user interface block 610 to allow the audio playing device 10 to inform the user of prayer time through, for example, a flashing light or an audible instruction.

The audio playing device 10 may also detect the motion 632 of the user through the motion and position sensors 618 and detect the user's voice 630. The device 10 may use this information when guiding the user through an activity to determine when, for example, to proceed to the next step instead of pausing or being silent for a predetermined time.

While examples have been used to disclose the invention, including the best mode, and also to enable any person skilled in the art to make and use the invention, the patentable scope of the invention is defined by claims, and may include other examples that occur to those skilled in the art. Accordingly the examples disclosed herein are to be considered non-limiting. Indeed, it is contemplated that any combination of features disclosed herein may be combined with any other or combination of other features disclosed herein without limitation.

Furthermore, in describing preferred embodiments, specific terminology is resorted to for the sake of clarity. However, the invention is not intended to be limited to the specific terms so selected, and it is to be understood that each specific term includes all equivalents.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

What is claimed is:

1. A portable audio playing device for facilitating the performance of an activity, comprising:
a) a head mounted enclosure that is configured for positioning on at least one ear of a user when the device is in use;
b) a memory area contained within the enclosure, the memory area providing storage space for a plurality of audio files; and
c) a programmable unit contained within the enclosure that is operable to convert said audio files into sound, the programmable unit being programmed to cause the audio playing device to guide a user through the performance of at least one of a plurality of pre-defined activities.

2. The audio playing device of claim 1, wherein the programmable unit comprises one or more elements of a set consisting of a controller, a microprocessor, a digital signal processor and a programmable logic device.

3. The audio playing device of claim 1, further comprising software code stored in the memory area that when executed by the programmable unit causes the audio playing device to guide a user through the performance of at least one of a plurality of pre-defined activities.

4. The audio playing device of claim 1, wherein the audio files comprise a plurality of process audio files related to the steps of executing the selected activity and a plurality of content audio files related to the core of the selected activity.

5. The audio playing device of claim 4, wherein the audio files further comprise a plurality of voice prompt audio files to allow the user to select one of a plurality of pre-defined activities.

6. The audio playing device of claim 5, wherein at least one of the voice prompt audio files comprises a welcome message audio file that describes the different pre-defined activities of the audio playing device.

7. The audio playing device of claim 5, wherein at least one of the voice prompt audio files comprises an audio menu file, each audio menu file used to prompt the user to choose a desired selection.

8. The audio playing device of claim 7, wherein the user chooses the desired selection by clicking a button.

9. The audio playing device of claim 5, wherein at least one of the voice prompt audio files comprises an audio confirmation file, each audio confirmation file informing the user of a current setting of an option and providing the user with the opportunity to change the current setting of the option.

10. The audio playing device of claim 4, wherein each process file comprises a prayer process audio file.

11. The audio playing device of claim 7, wherein each prayer process audio file comprises an Arabic file read during prayer.

12. The audio playing device of claim 4, wherein each content audio file comprises a Quran section audio file.

13. The audio playing device of claim 12, wherein the entire Quran is contained in the plurality of Quran section audio files.

14. The audio playing device of claim 7, wherein the programmable unit is programmed to cause the audio playing device to play an audio menu file and to receive the user′ selection choice, the audio playing device being further programmed to initiate the performance of the pre-defined activity corresponding to the user's selection choice.

15. The audio playing device of claim 14, wherein the performance of the pre-defined activity is the performance of a religious activity.

16. The audio playing device of claim 15, wherein the religious activity includes the playing of a Quran section audio file.

17. The audio playing device of claim 7, wherein the programmable unit is programmed to cause the audio playing device to play an audio menu file and to receive the user′ selection choice, the audio playing device being further programmed to play an option menu file in response to the user's selection choice.

18. The audio playing device of claim 17, wherein through the use of the option menu file the audio playing device provides the user with the ability to set up persistent user preferences for the performance of a pre-defined activity.

19. The audio playing device of claim 1, wherein the programmable unit comprises a microprocessor that is programmed through a program stored in the memory area.

20. The audio playing device of claim 1, further comprising a location detector for determining location coordinates of the user, the audio playing device being programmed to use the location coordinates to determine the direction to which a user must turn to face a destination location.

21. The audio playing device of claim 20, wherein said location detector comprises a GPS device.

22. The audio playing device of claim 21, wherein said destination location is Mecca.

23. The audio playing device of claim 20, further comprising a user orientation detector for determining an orientation of the user, the audio playing device being programmed to use the orientation of the user to guide the user to face a destination location.

24. The audio playing device of claim 23, wherein said user orientation detector is a digital compass.

25. The audio playing device of claim 7, further comprising a voice recognition system for detecting a voice command from the user, the voice command being used to indicate the desired selection.

26. The audio playing device of claim 1, further comprising a motion detector for detecting the movement of the user's body to a certain position.

27. The audio playing device of claim 1, further comprising a connector for providing a communication path between the audio playing device and a computer having a video display, wherein the user can use the video display and the computer to select the activity to be performed.

28. The audio playing device of claim 3 wherein one of the pre-defined activities comprises playing a media file to help the user memorize the material played.

29. The audio playing device of claim 28 wherein the material comprises passages in a religious document

30. The audio playing device of claim 28 wherein the material comprises words recited in another language.

31. An integrated programmable portable audio playing device comprising a headset configured for positioning on at least one ear of an user, the headset containing a controller, memory, and a speaker, the memory containing software code that provides instructions to the controller for controlling the operation of the audio playing device, the memory containing a plurality of pre-recorded audio clips, and the speaker providing an audio sound to guide the user through the performance of a religious activity.

32. A method for guiding a user through a pre-determined activity in an integrated head mounted audio playing device having a controller and memory containing programming for the controller and audio files of a welcome message, menu selections, acknowledgement messages, and content media files, the method comprising:
a) receiving an actuation command from an input key;
b) playing an audible welcome message;
c) playing audible menu selections from which a user may select one of a plurality of pre-determined activities in which to engage;
d) receiving the user selection of the pre-determined activity;
e) playing an acknowledgement message corresponding to the user selection;
f) determining if the user chose to repeat the previous stage of the pre-determined activity; and
g) performing the appropriate stage of the pre-determined activity.

33. The method of claim 32, wherein the step of performing the appropriate stage of the predetermined activity comprises:
a) playing an introductory phrase audio file;
b) playing an Al Fateha audio file;
c) playing a first section of the content media files followed by playing a first pause file;
d) playing a rukuu audio file followed by playing a second pause file;
e) playing a sujud audio file followed by playing a third pause file;
f) playing an intermediate phrase audio file followed by playing a pause file;
g) playing the Al Fateha audio file;
h) playing a second section of the content media files;
i) playing the rukuu audio file followed by playing the second pause file;
j) playing the sujud audio file followed by playing the third pause file;
k) playing the introductory phrase followed by playing a forth pause file; and
l) playing a closing audio file.

34. The method of claim 32, wherein the pre-determined activity is a religious activity.

35. The method of claim 32, wherein the predetermined activity is a religious activity that includes playing a section of Quran files.

36. A programmable portable audio playing device for facilitating the performance of an activity, comprising:
a) a head mounted enclosure that is configured for positioning on at least one ear of a user when the device is in use;
b) a memory area contained within the enclosure, the memory area providing storage space for a plurality of audio files; and
c) a programmable unit contained within the enclosure that is operable to convert said audio files into sound, the programmable unit being programmed to cause the audio playing device to guide a user through a prayer sequence.
